(19) United States
(12) Patent Application Publication
(10) Pub. No.: US 2014/0321155 A1
(43) Pub. Date: Oct. 30, 2014

(54) Light Guide Plate Structure Controlling Uniformity from Central Portion to Edge, and Lighting Lamp Using Same

(71) Applicant: Mee Suk Rho, Seongnam-si Gyeonggi-do (KR)

(72) Inventor: Mee Suk Rho, Seongnam-si Gyeonggi-do (KR)

(73) Assignee: TECHSIGN LIGHT PANEL CO., LTD., Gongju-si Chungcheongnam-do (KR)

(21) Appl. No.: 14/360,924

(22) PCT Filed: May 11, 2012
(86) PCT No.: PCT/KR2012/003718

§ 371 Date: May 27, 2014

(30) Foreign Application Priority Data
May 7, 2012 (KR) 10-2012-0048092

(51) Int. Cl. F21V 8/00

(52) U.S. Cl. CPC G02B 6/0021; G02B 6/0068
USPC 362/606; 362/621; 362/611; 362/612

(57) ABSTRACT

The objective of the present invention is to orient an LED emitting surface not toward an upper surface, but rather toward a portion of a light guide plate on which the light is incident by using the scattering pattern of the light guide plate, and then maintain the uniformity of the distribution of the light emitted from the light guide plate by means of a scattering pattern of the light guide plate, in order to increase light-emitting efficiency. Provided is a light guide plate structure controlling light uniformity from a central portion to an edge, which includes said light guide plate having a hole in the center thereof for accommodating a light source means, wherein the light from the light source means is incident thereon, said light source means being arranged so as to emit light laterally through the incident light portion of the hole, the light guide plate being provided, on the upper surface thereof, with the scattering pattern, the size per unit area of which gradually increases from the central portion toward the edge such that the light distribution is uniform, wherein the light source means is accommodated in the hole of the light guide plate so as to emit light to the portion of the light guide plate on which the light is incident. The invention further relates to a lighting lamp using the same.

### TECHNICAL FIELD

The present invention relates to a light guide plate structure having uniformly controlled light distribution from a center portion to an edge, in which a light source means are accommodated in a center hole of the light guide plate for preventing decrease of light emitting efficiency so as to scatter light laterally incident on a light incident section through a predetermined scattering pattern such that light emitted from the light guide plate is uniformly distributed between the central portion and the edge, and a lighting lamp using the same.

### BACKGROUND ART

A light guide plate is a part which performs a function of lighting a back light unit (BLU) with uniform luminance, and refers to an acryl injection-molded product which is assembled in the BLU that guides light to a liquid crystal in a liquid crystal display (LCD). The light guide is one of plastic molded lenses that play a role of uniformly transmitting the light emitted from a cold cathode fluorescent lamp (CCFL) to the whole surface of the LCD.

Meanwhile, an LED, which is a light source using the light emission phenomenon of injection type electroluminescence that emits light in response to electric current, has advantages of excellent optical properties and thousands of potential colors, so that it is used in outdoor architectural lighting.

Because such an LED has excellent directed light properties and brightness, a structure of an LED lighting lamp including a small number of LEDs in the center has become possible.

FIG. 1 is a diagram showing a conventional LED lighting lamp structure provided with a light source in a center portion, and FIG. 2 is a plan view showing a scattering pattern of the conventional LED lighting lamp.

In the lighting lamp having the light source in the center portion, as shown in FIG. 1, light from the LED is irradiated toward an emitting surface, and then the light is diffused through a diffusion plate. By this configuration, the distance from the LED to the diffusion plate is increased so as to maintain a wide range of irradiation angle from the LED in the center, thereby the thickness of the product becomes thicker.

Further, because the LED is positioned in the center, the brightest light emits to the center from the light source, so that a light shielding pattern is used to make light uniform.

Because light intensity is strongest in the center portion, the patterns in the center portion are made bigger so as to shield much light and the size of the pattern is made smaller from the center portion toward the edge portion, as shown in FIG. 2.

However, since the brightness in the center portion is reduced by patterns in order to make the brightness of the center portion and the brightness in the edge portion uniform, there is a problem that the brightness of the whole of the lighting lamp decreases if patterns are applied, as shown in the graph of FIG. 1.

### SUMMARY OF INVENTION

### Technical Problem

Accordingly, in consideration of the above-mentioned circumstances, it is an object of the present invention to provide a light guide plate structure having uniformly controlled light distribution from a center portion to an edge, which is capable of uniformly maintaining light distribution from the center portion to the edge portion without a decrease of the brightness by using a scattering pattern of the light guide plate, and a lighting lamp using the same.

Another object of the present invention is to provide a light guide plate structure having uniformly controlled light distribution from a center portion to an edge, in which the thickness of the whole of the lighting lamp is thinner, and a lighting lamp using the same.

Another object of the present invention is to provide a light guide plate structure having uniformly controlled light distribution from a center portion to an edge, which is capable of easily forming the light guide plate in various designs, and a lighting lamp using the same.

### Technical Solution

In order to accomplish the foregoing objects, according to an aspect of the present invention, there is provided a light guide plate structure having uniformly controlled light distribution from a center portion to an edge, the light guide plate structure characterized in that: a hole is formed in the center to accommodate a light source means, light from the light source means, which is disposed so as to emit light laterally, is incident through a light incident section of the hole, and a scattering pattern whose size per unit area increases gradually from the center portion toward the edge is formed on an upper surface thereof so as to uniformly distribute light.

According to the present invention, the light incident section of the hole may be formed in a flat surface or a curved surface.

According to the present invention, wherein an angle of the light incident through the light incident section of the hole may range from 90 to 120 degrees.

In order to accomplish the foregoing objects, according to another aspect of the present invention, there is provided a lighting lamp using a light guide plate structure having uniformly controlled light distribution from a center portion to an edge, including: the light guide plate in which a hole is formed in the center to accommodate a light source means, light from the light source means, which is disposed so as to emit light laterally, is incident through a light incident section of the hole, and a scattering pattern whose size per unit area increases gradually from the center portion toward the edge is formed on an upper surface thereof so as to uniformly distribute light; and the light source means which is accommodated in the hole of the light guide plate to emit light to the light incident section of the light guide plate.

According to the present invention, the lighting lamp may further include a diffusion plate formed on the upper surface of the light guide plate to diffuse light.

According to the present invention, the lighting lamp may further include a reflection plate formed on a lower surface of the light guide plate to reflect light.

According to the present invention, the light source means may include: a plurality of LEDs configured to emit light in a direction of the light incident section of the light guide hole; and an SMPS which is disposed in the center of the light guide hole to drive the LEDs.

According to the present invention, the light guide plate may have a circular or polygonal shape.

### Advantageous Effects

According to the light guide plate having uniformly controlled light distribution from a center portion to an edge and the lighting lamp using the same of the present invention, the light distribution between the center portion and the edge portion is uniform without the decrease of the brightness of light by using the scattering pattern of the light guide plate, so that the thickness of the whole of the lighting lamp becomes thinner, and it is possible to form the light guide plate in various designs.

### BRIEF DESCRIPTION OF THE DRAWINGS

FIG. 1 is a diagram showing a distribution of brightness in a conventional LED lighting lamp provided with a light source in a center portion.

FIG. 2 is a plan view showing a scattering pattern of the conventional LED lighting lamp.

FIG. 3 is a perspective view of a light guide plate according to an embodiment of the present invention.

FIG. 4 is a cross-sectional view of an LED lighting lamp having a light guide plate structure according to the embodiment of the present invention.

FIG. 5 is a diagram showing a distribution of brightness in the LED lighting lamp having the light guide plate structure according to the embodiment of the present invention.

FIG. 6 is a plan view showing a scattering pattern of the LED lighting lamp having the light guide plate structure according to the embodiment of the present invention.

FIG. 7 is a view showing light emitting regions in an emitting means including four LEDs according to the embodiment of the present invention.

FIG. 8 is a view showing the light emitting regions in an emitting means including five LEDs according to the embodiment of the present invention.

FIGS. 9 and 10 are plan views showing polygonal light guide plate structures according to the embodiment of the present invention, respectively.

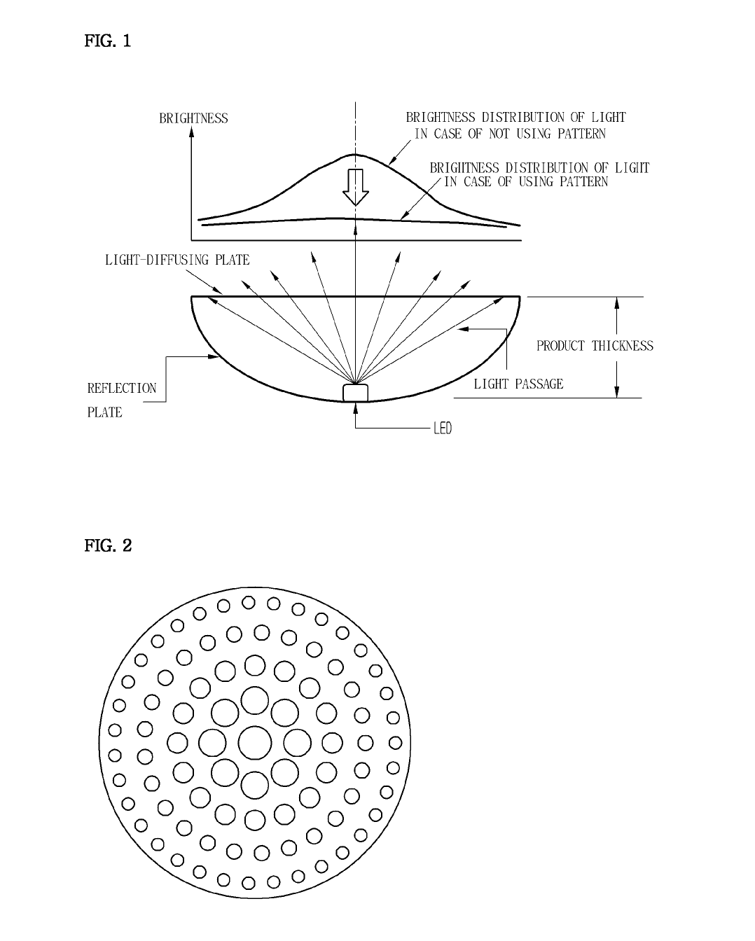

### DETAILED DESCRIPTION OF SPECIFIC EMBODIMENTS

Terms or words used in the specification and claims should not be construed as limited to a lexical meaning, and should be understood as appropriate notions by the inventor based on that she is able to define terms to describe her invention in the best way to be seen by others.

Therefore, embodiments and drawings described herein are simply exemplary and not exhaustive, and it will be understood that various modifications and equivalents may be made to take the place of the embodiments.

Hereinafter, a light guide plate structure having uniformly controlled light distribution from a center portion to an edge and a lighting lamp using the same will be described with reference to the accompanying drawings.

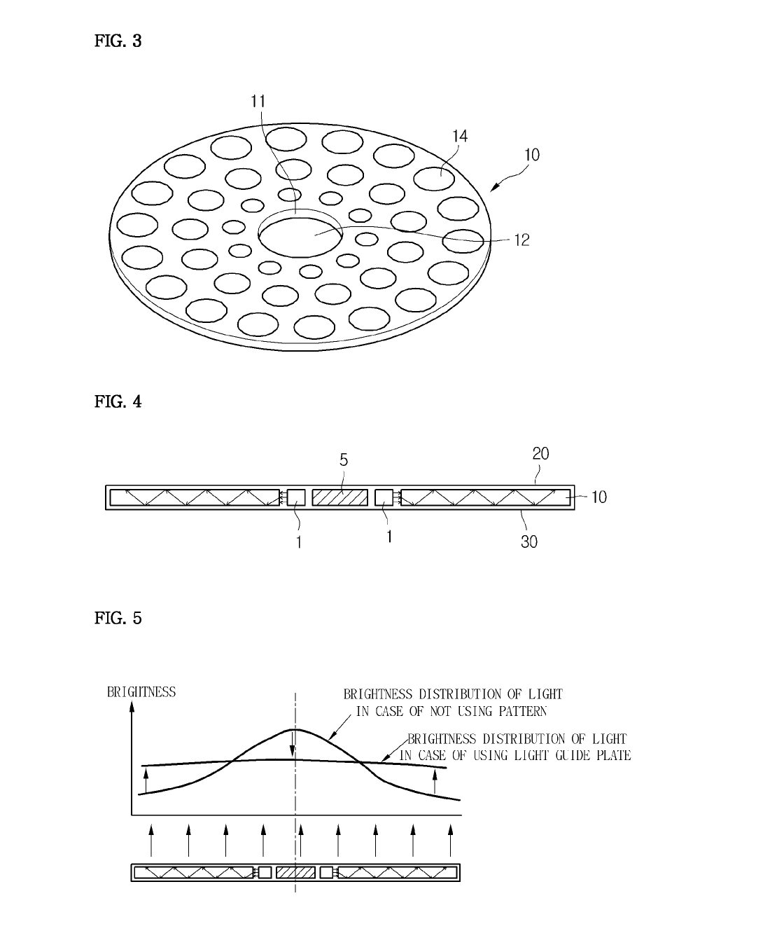

FIG. 3 is a perspective view of the light guide plate according to an embodiment of the present invention, and FIG. 4 is a cross-sectional view of an LED lighting lamp having the light guide plate structure according to the embodiment of the present invention.

As shown in FIGS. 3 and 4, a light plate guide 10 having uniformly controlled light distribution from a center portion to an edge in a radial direction includes: a hole 12 formed in a center thereof for accommodating a light source means 1 and 5; and scattering patterns 14 whose size per unit area increases from the center portion toward the edge, such that light from the light source means 1 and 5, which are disposed so as to emit light laterally, is incident through a light incident section 11 of the hole 12 and then diffuses through the scattering patterns, thereby making light distribution uniform.

Further, a lighting lamp using the light guide plate 10 having such a configuration includes: the light guide plate 10; the light source means 1 and 5 which are accommodated in the hole 12 of the light guide plate 10 to emit light to the light incident section 11 of the light guide plate 10; a light diffusion plate 20 which is mounted on an upper surface of the light guide plate 10 to diffuse light; and a reflection plate 30 which is mounted on a lower surface of the light guide plate 10 to reflect light. Herein, the light source means 1 and 5 include: a plurality of LEDs 1 which is disposed in the hole 12 of the light guide plate 10 to emit light in a direction of the light incident section 11; and a switched-mode power supply (SMPS) 5 which is disposed in the center of the hole 12 of the light guide plate 10 to drive the LEDs 1.

When the SMPS 5 is installed in the center of the hole 12 of the light guide plate 10, it is possible to easily repair a failed component on the upper surface thereof in a case of any problem occurring during use in the future.

Although not shown in drawings, it is preferable that the light guide plate 10 is formed in a cover type so as to easily accommodate the light source means 1 and 5 in the center of the hole 12 of the light guide plate 10 or easily maintain and repair the related components.

The reflection plate 30 may include any one of an ultrafine foamed light reflection plate, a reflection plate emulsified with titanium white particles, and a reflection plate with poly-tetrafluoro-ethylene (PTFE) particles or a combination thereof.

According to the light guide plate 10 having the above-described configuration, emitting surfaces of LEDs 1 face the light incident section 11 rather than the upper surface of the light guide plate 10, and the incident light is emitted through the scattering pattern 14 formed on the light guide plate 10, such that the distribution of light emitting from the light guide plate 10 is maintained uniform so as to increase the light emitting efficiency.

FIG. 5 is a diagram showing brightness distribution according to the LED lighting lamp having the light guide plate structure according to the embodiment of the present invention.

As shown in FIG. 5, if light is irradiated to the light incident section 11 by using the light guide plate 10 structure in which the SMPS 5 and LEDs 1 are accommodated in the hole 12 of the center portion of the light guide plate 10, it can be seen that light brightness distribution becomes uniform without a damping phenomenon.

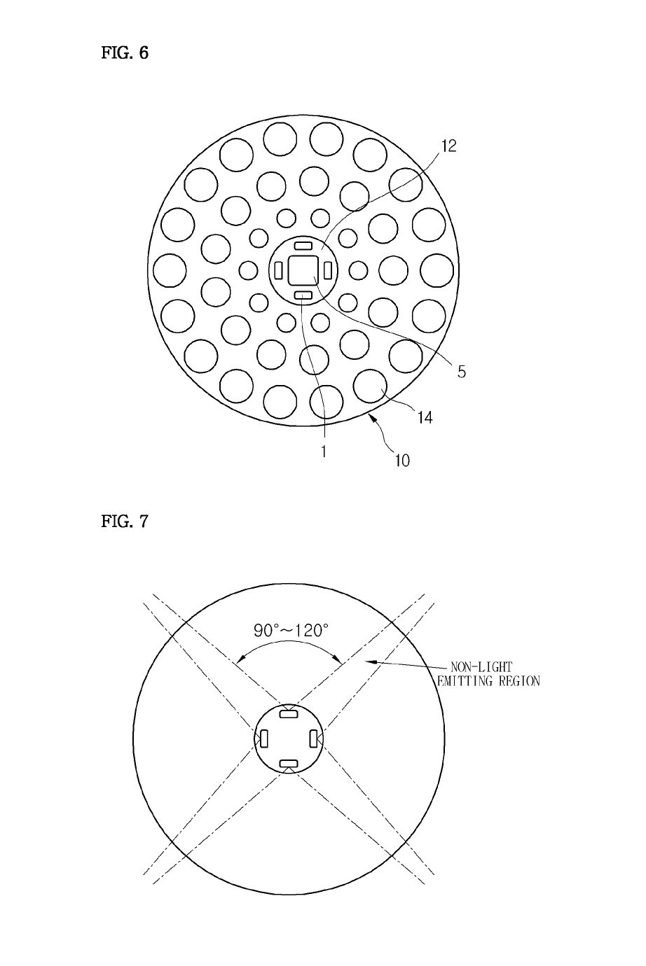

FIG. 6 is a plan view showing the scattering pattern of the LED lighting lamp having the light guide structure according to the embodiment of the present invention.

The scattering pattern 14 of the light guide plate 10 is configured in such a manner that the size per unit area increases from the center portion toward the edge in the radial direction, as shown in FIG. 6.

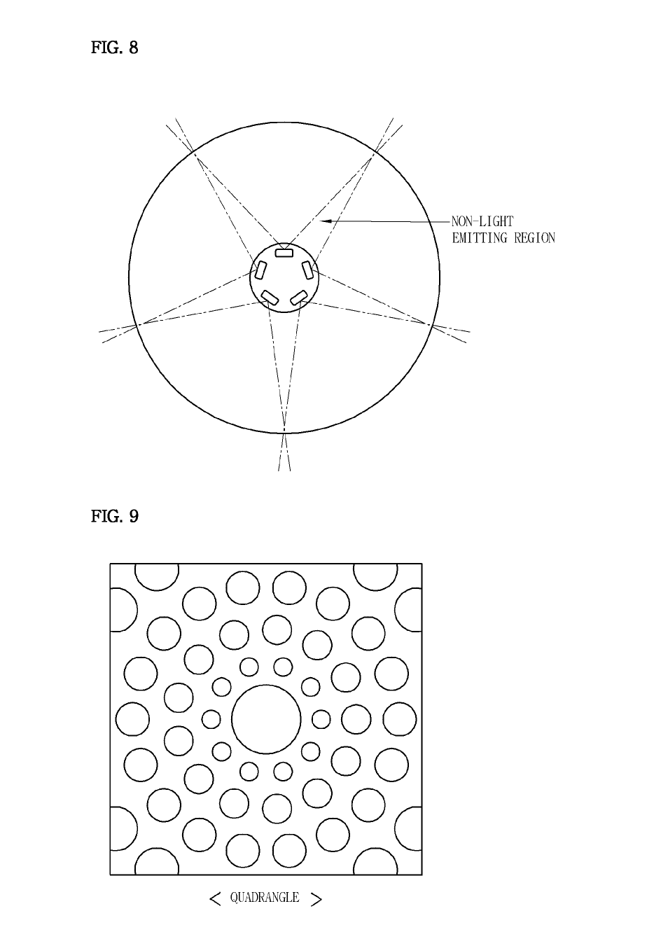

FIG. 7 is a view showing light emitting regions in a light emitting means including four LEDs according to the embodiment of the present invention, and FIG. 8 is a view showing the light emitting regions in a light emitting means including five LEDs according to the embodiment of the present invention.

When light from the LEDs 1 is incident to the light guide plate 10, an angle of the light incident through the light incident section 11 ranges from 90 to 120 degrees. This is because if the light incident section 11 is formed in a flat surface, the incident angle is 90 degrees, and if the light incident section 11 is formed in a curved surface, the incident angle is 120 degrees.

As shown in FIG. 7, if the lighting lamp includes four LEDs 1, non-light emitting regions occur depending on the positions of LEDs. In order to solve this problem, it is preferable to use five or more LEDs 1 as shown in FIG. 8.

Therefore, the number of LEDs 1 may be appropriately utilized in consideration of the non-light emitting region, and it may also be adjusted depending on the size of the lighting lamp, without being particularly limited to the number of LEDs.

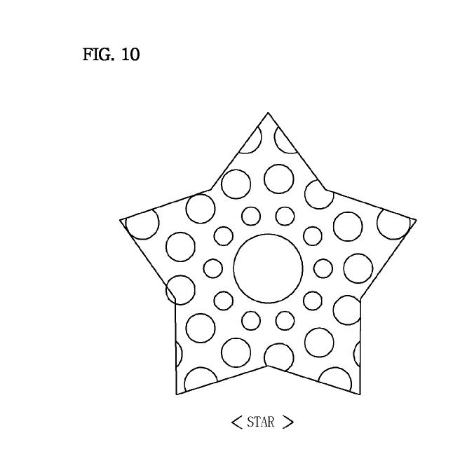

FIGS. 9 and 10 are plan views showing polygonal light guide plate structures according to the embodiment of the present invention, respectively.

As shown in FIGS. 9 and 10, the light plate guide 10 having uniformly controlled light distribution from a center portion to an edge in a radial direction includes: the hole 12 formed in a center thereof for accommodating a light source means 1 and 5; and the scattering patterns 14 whose size per unit area increases from the center portion toward the edge, such that light from the light source means 1 and 5, which are disposed so as to emit light laterally, is incident through the light incident section 11 of the hole 12 and then diffuses through the scattering patterns, thereby making light distribution uniform. Therefore, the thickness of the edge may be made at 5 mm or less, and the molding may be also made at a minimum size.

In addition, since the light source means 1 and 5 are accommodated in the center of the light guide plate 10, it is easy to configure not only a circular design but also polygonal designs of various shapes such as a quadrangle as shown in FIG. 9 and a star shape as shown in FIG. 10.

While the present invention has been described with reference to the preferred embodiments, the present invention is not limited to the above-described embodiments, and it will be understood by those skilled in the related art that various modifications and variations may be made therein without departing from the scope of the present invention as defined by the appended claims.

SEQ ID NO. Free Text None

What is claimed is:

1. A light guide plate structure having uniformly controlled light distribution from a center portion to an edge, the light guide plate structure characterized in that:
a hole is formed in the center to accommodate a light source means,
light from the light source means, which is disposed so as to emit light laterally, is incident through a light incident section of the hole, and
a scattering pattern whose size per unit area increases gradually from the center portion toward the edge is formed on an upper surface thereof so as to uniformly distribute light.

2. The light guide plate structure according to claim 1, wherein the light incident section of the hole is formed in a flat surface or a curved surface.

3. The light guide plate structure according to claim 2, wherein an angle of the light incident through the light incident section of the hole ranges from 90 to 120 degrees.

4. A lighting lamp using a light guide plate structure having uniformly controlled light distribution from a center portion to an edge, comprising:
the light guide plate in which a hole is formed in the center to accommodate a light source means, light from the light source means, which is disposed so as to emit light laterally, is incident through a light incident section of the hole, and a scattering pattern whose size per unit area increases gradually from the center portion toward the edge is formed on an upper surface thereof so as to uniformly distribute light; and
the light source means which is accommodated in the hole of the light guide plate to emit light to the light incident section of the light guide plate.

5. The lighting lamp according to claim 4, wherein the light incident section of the hole is formed in a flat surface or a curved surface.

6. The lighting lamp according to claim 5, wherein an angle of the light incident through the light incident section of the hole ranges from 90 to 120 degrees.

7. The lighting lamp according to claim 4, further comprising a diffusion plate formed on the upper surface of the light guide plate to diffuse light.

8. The lighting lamp according to claim 7, further comprising a reflection plate formed on a lower surface of the light guide plate to reflect light.

9. The lighting lamp according to claim 4, wherein the light source means includes:
a plurality of LEDs configured to emit light in a direction of the light incident section of the light guide hole; and
an SMPS which is disposed in the center of the light guide hole to drive the LEDs.

10. The lighting lamp according to claim 4, wherein the light guide plate has a circular or polygonal shape.
